(19) United States
(12) Patent Application Publication
(10) Pub. No.: US 2014/0136503 A1
(43) Pub. Date: May 15, 2014

(54) PERSONALIZED SEARCH RESULT RE-RANK BASED ON RELATIONSHIP BOND STRENGTH ALTERATION AMONG DIFFERENT KEYWORDS

(71) Applicant: INTERNATIONAL BUSINESS MACHINES CORPORATION, Armonk, NY (US)

(72) Inventors: Barry Alan Kritt, Raleigh, NC (US); Sarbajit Kumar Rakshit, Kolkata (IN)

(73) Assignee: INTERNATIONAL BUSINESS MACHINES CORPORATION, Armonk, NY (US)

(21) Appl. No.: 13/673,567

(22) Filed: Nov. 9, 2012

(51) Int. Cl. G06F 17/30

(52) U.S. Cl. 707/706; 707/723; 707/E17.108

(57) ABSTRACT

An apparatus for searching includes a keyword display module, a keyword selection module, a bond strength selection module, and a results display module. The keyword display module displays keywords on an electronic display. The keywords are from results of an internet search of search criteria. A keyword of a search result is related to another keyword of the search result with a particular bond strength and the bond strength includes an amount that keywords in a search result are related. The keyword selection module that receives a selection two or more of the displayed keywords, the bond strength selection module that sets a bond strength between two or more of the selected keywords, and the results display module that displays search results with a bond strength of at least the selected bond strength.

### FIELD

The subject matter disclosed herein relates to keyword searches and more particularly relates to keyword searches based on bond strength between the keywords.

### BACKGROUND

### Description of the Related Art

Many internet users often use web search engines to search for webpages available on the internet or other private networks. Web search engines often return thousands or even millions of search results. A user may need to page through many search results to find a webpage that has desired material. If a user wants to refine search results, often the user enters search criteria with different search terms. Additional search terms may or may not narrow search results in a way that the user finds desired results.

### BRIEF SUMMARY

An apparatus for searching is disclosed. A method, computer program product, and system also perform the functions of the method. An apparatus for searching includes a keyword display module, a keyword selection module, a bond strength selection module, and a results display module. The keyword display module displays keywords on an electronic display. The keywords are from results of an internet search of search criteria. A keyword of a search result is related to another keyword of the search result with a particular bond strength and the bond strength includes an amount that keywords in a search result are related. The keyword selection module receives a selection two or more of the displayed keywords, the bond strength selection module sets a bond strength between two or more of the selected keywords, and the results display module displays search results with a bond strength of at least the selected bond strength.

In one embodiment, the apparatus includes a bond strength module that determines a bond strength of keywords of a webpage. In another embodiment, the apparatus includes a keyword module that identifies keywords from the webpage prior to the bond strength module determining a bond strength of the keywords of the webpage. In a further embodiment, the apparatus includes an accumulation module that crawls the internet to locate webpages for the keyword module to identify keywords and for the bond strength module to determine bond strengths and stores the keywords and the bond strengths of the webpages.

In one embodiment, the bond strength module determines bond strengths of the keywords of webpages within the search results. In a further embodiment, the apparatus includes a search result keyword module that identifies the keywords from the webpages of the search results prior to the bond strength module determining a bond strength of the keywords of the webpages. In another embodiment, the bond strength module determines bond strengths of a subset of webpages of the search results. In yet another embodiment, the subset includes a number of webpages listed first within the search results.

In one embodiment, the bond strength module executes associated with a search engine. In another embodiment, the bond strength module executes associated with a browser. In another embodiment, the keyword display module displays a subset of the keywords. In another embodiment, the apparatus includes a bond strength sorting module that sorts the search results based on the selected keywords. In another embodiment, the bond strength selection module displays a slider and a user moves the slider to select the bond strength. In another embodiment, the bond strength selection module includes a first bond strength selection for a first set of keywords and a second bond strength selection for a second set of keywords.

A method for searching includes displaying keywords on an electronic display. The keywords are from results of an internet search of search criteria. A keyword of a search result is related to another keyword of the search result with a particular bond strength and the bond strength includes an amount that keywords in a search result are related. The method includes receiving a selection of two or more of the displayed keywords, setting a bond strength between two or more of the selected keywords, and displaying search results with a bond strength of at least the selected bond strength.

The method, in one embodiment, includes identifying keywords of a webpage and determining a bond strength of keywords of the webpage. In another embodiment, the method includes crawling the internet to locate webpages to identify the keywords and to determine the bond strengths and storing the identified keywords and determined bond strengths. In another embodiment, the method includes determining bond strengths of the keywords of webpages within the search results.

A computer program product for refining search results is included. The computer program product includes a computer readable storage medium having program code embodied therein. The program code is readable and/or executable by a processor to crawl the internet to locate webpages and identify keywords for each webpage. A keyword of a search result is related to another keyword of the search result with a particular bond strength and the bond strength includes an amount that keywords in a search result are related. The program code is readable and/or executable by a processor to determine a bond strength between keywords for each webpage, store the keywords and bond strengths of each webpage, and display keywords on an electronic display, where the keywords are from results of an internet search of search criteria. The program code is readable and/or executable by a processor to receive a selection of two or more of the displayed keywords, set a bond strength between two or more of the selected keywords, and display search results with a bond strength of at least the selected bond strength.

A system for searching includes a server and a web search engine executing on the server that crawls the internet to locate webpages. The system includes a keyword module that identifies keywords for each webpage. A keyword of a search result is related to another keyword of the search result with a particular bond strength and the bond strength includes an amount that keywords in a search result are related. The system includes a bond strength module that determines a bond strength between keywords for each webpage, an accumulation module that stores the keywords and bond strengths of each webpage, and a keyword display module that displays keywords on an electronic display. The keywords are from results of an internet search of search criteria. The system includes a keyword selection module that receives a selection of two or more of the displayed keywords, a bond strength selection module that sets a bond strength between two or more of the selected keywords, and a results display module that displays search results with a bond strength of at least the selected bond strength.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating one embodiment of a system for reordering search results based on bond strength;

FIG. 1B is a schematic block diagram illustrating an alternate embodiment of a system for reordering search results based on bond strength;

FIG. 2 is a schematic block diagram illustrating one embodiment of an apparatus for reordering search results based on bond strength;

FIG. 3 is a schematic block diagram illustrating one embodiment of an apparatus for reordering search results based on bond strength;

FIG. 4A is a first part of an example of a webpage of a browser for reordering search results based on bond strength;

FIG. 4B is a second part of an example of a webpage of a browser for reordering search results based on bond strength;

FIG. 5 is a schematic flow chart diagram illustrating one embodiment of a method for reordering search results based on bond strength;

FIG. 6 is a schematic flow chart diagram illustrating another embodiment of a method for reordering search results based on bond strength; and

FIG. 7 is a schematic flow chart diagram illustrating one embodiment of a method for reordering, after a search, search results based on bond strength.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same computer program product via shared execution, transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the computer program product. The summed measurements of use units are periodically multiplied by unit costs and the resulting total computer program product service costs are alternatively sent to the customer and or indicated on a web site accessed by the customer which then remits payment to the service provider.

In one embodiment, the service provider requests payment directly from a customer account at a banking or financial institution. In another embodiment, if the service provider is also a customer of the customer that uses the computer program product, the payment owed to the service provider is reconciled to the payment owed by the service provider to minimize the transfer of payments.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

In one embodiment, software applications and version numbers are identified and compared to the list of software applications and version numbers that have been tested to work with the computer program product. Those software applications that are missing or that do not match the correct version will be upgraded with the correct version numbers. Program instructions that pass parameters from the computer program product to the software applications will be checked to ensure the parameter lists match the parameter lists required by the computer program product. Conversely parameters passed by the software applications to the computer program product will be checked to ensure the parameters match the parameters required by the computer program product. The client and server operating systems including the network operating systems will be identified and compared to the list of operating systems, version numbers and network software that have been tested to work with the computer program product. Those operating systems, version numbers and network software that do not match the list of tested operating systems and version numbers will be upgraded on the clients and servers to the required level.

In response to determining that the software where the computer program product is to be deployed, is at the correct version level that has been tested to work with the computer program product, the integration is completed by installing the computer program product on the clients and servers.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

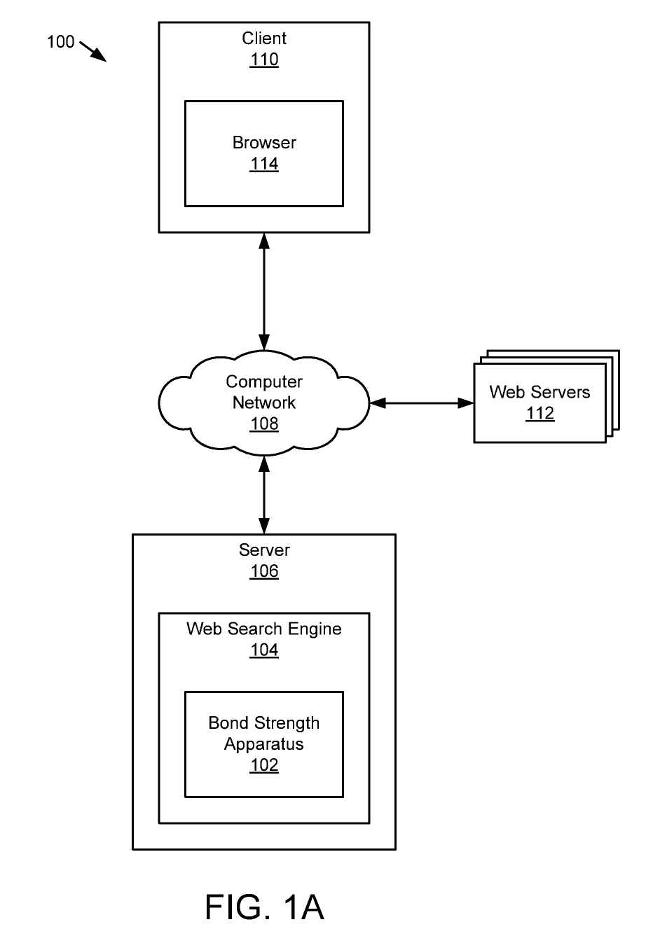

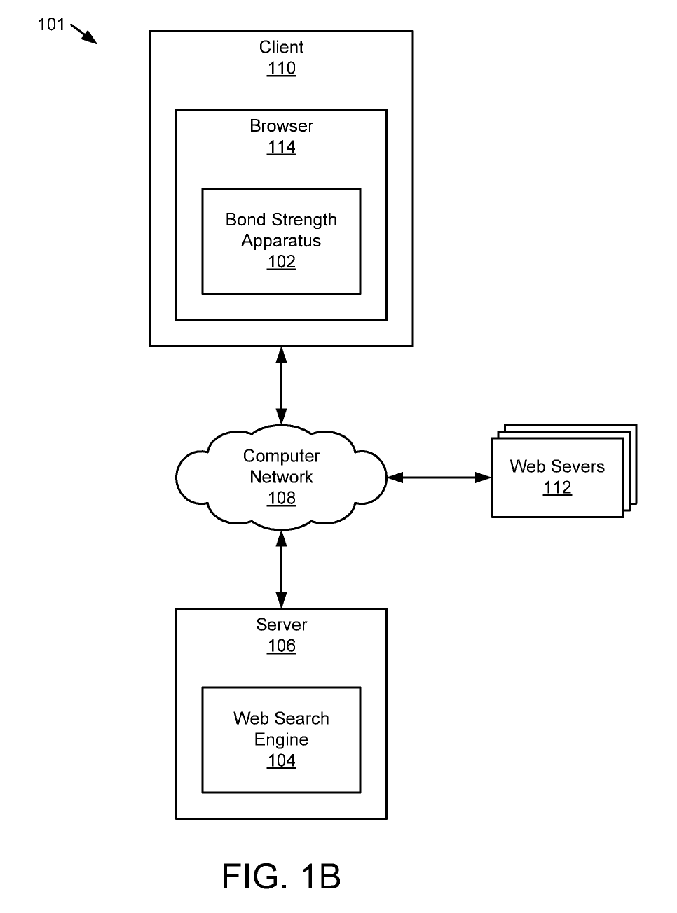

FIG. 1A is a schematic block diagram illustrating one embodiment of a system 100 for reordering search results based on bond strength. The system 100 includes a bond strength apparatus 102 within a web search engine 104 on a server 106, a computer network 108, a client 110 with a browser 114, and web servers 112, which are described below.

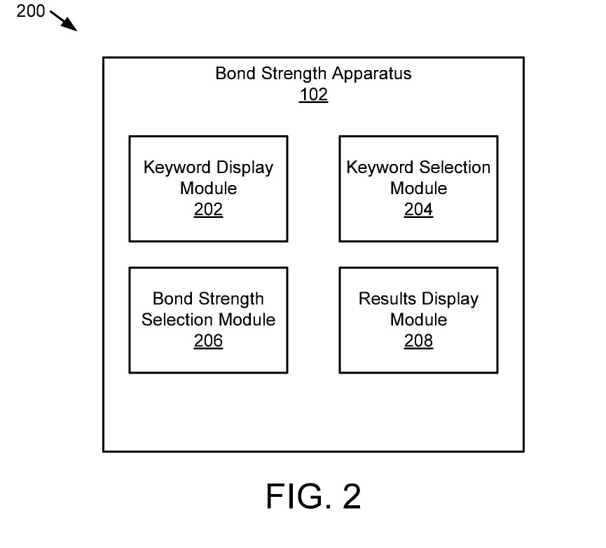

In one embodiment, the system 100 includes a bond strength apparatus 102 within a web search engine 104 on a server 106. The bond strength apparatus 102 organizes search results based on a bond strength between two or more keywords. The bond strength apparatus 102 is described in more detail with respect to the apparatus 200 of FIG. 2. The web search engine 104 searches the internet based on search criteria to identify webpages related to the search criteria. For example, a user may access a web search engine 104 through a web browser 114. The user may type in a URL (uniform resource locator) of the web search engine 104 to access the web search engine 104. A webpage of the web search engine 104 may display a search screen in the browser 114 that allows the user to enter search criteria. For example, the search screen may allow a user to enter search criteria with a user interface, such as a keyboard or mouse. In another embodiment, the user submits a file with search criteria. In another example, the web search engine 104 may include an application installed on the client 110 that accesses the web search engine 104.

The server 106 may be a mainframe computer, a blade server, a workstation, a desktop computer, or other computer. The server 106, in one embodiment, includes a plurality of processors, such as a partitioned mainframe with multiple operating system instances. In another embodiment, the server 106 includes one or more subsystems, such as a storage area network. The server 106, may access internal storage or external storage accessible through a network. In one embodiment, the server 106 is a server associated with the web search engine 104. For example, the server 106 may be part of a server farm controlled by a company that provides search services through a web search engine 104 available on the internet.

The system 100 includes a computer network 108 in communication with the server 106, the client 110, and web servers 112. The computer network 108 may be a single network or may include several computer networks 108 linked together. The computer network 108 may include a local area network (“LAN”), wide area network (“WAN”), wireless network, etc. The computer network 108 may include hardware such as the server 106, routers, switches, cabling, and other communication hardware. The computer network 108 may include the internet and access remote web servers 112 with web pages that satisfy search criteria for a web search. Web pages available to the web search engine 104 may be located within a proprietary computer network 108, such as within servers 106, web servers 112, etc. of a company or may be located external to a proprietary computer network 108 and may be available for public access. Web pages may include data, information, diagrams, photographs, music, files, or any other content available using a web search engine 104. One of skill in the art will recognize other content and web pages available for access by a web search engine 104 over one or more computer networks 108.

FIG. 1B is a schematic block diagram illustrating an alternate embodiment of a system 101 for reordering search results based on bond strength. The system 101 includes a web search engine 104, a server 106, a computer network 108, a client 110 with a browser 114, and web servers 112, which are substantially similar to those described above in relation to the system 100 of FIG. 1A. The system 101 also includes a bond strength apparatus 102 which is substantially similar to that described above in relation to the system 100 of FIG. 1A, but the bond strength apparatus 102 is located on the client 110 and is part of the browser 114 on the client 110. In the embodiment of the system 101 of FIG. 1B, the browser 114 accesses the internet and allows a user to access the web search engine 104 to enter a search and to receive search results from the web search engine 104. The bond strength apparatus 102 searches web pages identified in the search results to identify keywords and associated bond strengths.

The browser 114, in one embodiment, is an application installed on the client 110. In another embodiment, the browser 114 is located external to the client 110, for example on a server 106, storage area network, a cloud device, and etc. but is accessed by the client 110. The browser 114 typically allows a user to access webpages and to execute functions accessible on the webpages. For example, the browser 114 may allow the user to access a webpage that accesses the web search engine 104. In another embodiment, the bond strength apparatus 102 is distributed on two or more devices. For example, portions of the bond strength apparatus 102 may be located on the client 110 while other portions may be located on a server 106. One of skill in the art will recognize other ways that the bond strength apparatus 102 may be distributed.

FIG. 2 is a schematic block diagram illustrating one embodiment of an apparatus 200 for reordering search results based on bond strength. The apparatus 200 includes, in one embodiment, a bond strength apparatus 102 with a keyword display module 202, a keyword selection module 204, a bond strength selection module 206, and a results display module 208, which are described below.

The apparatus 200 includes a keyword display module 202 that displays keywords on an electronic display. The keywords are from results of an internet search (i.e. search results) of search criteria. For example, a user may open a window on a browser 114 and may navigate to a website of a web search engine 104. The user may enter search criteria, such as a topic, a title, a string of words, and the like. The web search engine 104 may return search results.

The search results, in one embodiment, include keywords. A keyword, in one embodiment, is a word associated with a webpage. For example, if a particular webpage included information regarding computer memory, words such as “capacity,” “cache,” “random,” “access,” “memory,” and the like may be included on the webpage and may be considered keywords. A keyword may relate to a topic, a subtopic, a subject, an element, etc. of the webpage. In one embodiment, a keyword is a word. In another embodiment, a keyword is a phrase or a string of words, such as “random access memory.” Keywords may be part of an overall topic of the webpage, may be part of a particular topic with in a webpage, may relate to a particular point made by the author of the contents of the webpage, may be headings for drawings, etc. One of skill in the art will recognize ways to identify keywords of a webpage. The keywords of search results may be returned in the form of metadata, a file, an attachment, a segment of a display, etc.

The keyword display module 202 displays the keywords returned with the search results. In one embodiment, the keyword display module 202 displays the keywords without user prompting or intervention. In another embodiment, the keyword display module 202 displays the keywords in response to user input. For example, once search results are displayed, the user may make a selection to display the keywords. In another embodiment, the user makes a setup selection so that the keyword display module 202 displays the keywords.

In one embodiment, the keyword display module 202 displays the keywords as a list in alphabetical order. In another embodiment, the keyword display module 202 displays the keywords based another criteria, such as number of times each keyword is displayed, etc. The keyword display module 202 may display all of the keywords or a subset of the keywords. For example, if there are more keywords than can fit on a screen, the keyword display module 202 may display the keywords in a list where the user can scroll down through the list. In another embodiment, t the keyword display module 202 displays a subset of the keywords without access to keywords not in the subset. For example, if search results result in 10,000 keywords, the keyword display module 202 may displays the top 1,000 keywords or may display keywords occurring a certain number of times in the webpages of the search results. In another embodiment, the keyword display module 202 displays the keywords along with a search field to allow a user to search the keywords for one or more particular keywords. One of skill in the art will recognize other ways that the keyword display module 202 may display the keywords.

In one embodiment, a particular keyword of the search result is related to another keyword of the search result with a particular bond strength. The bond strength is an amount that keywords in a search result are related. For example, keywords that are next to each other on a webpage may have a high bond strength while keywords spread far apart on a webpage may have a low bond strength and where one keyword is on a webpage and another keyword is not on the webpage, the bond strength between the keywords may be zero. Bond strength, in one embodiment, is affected by location of keywords. For example, one or more keywords in a title, heading, subject line, etc. may increase bond strength. For example, two keywords in a title may have a high bond strength while one or more of the keywords in footnotes may reduce bond strength.

In another embodiment, bond strength is affected by number of keywords. For example, two keywords that occur once each on a webpage may have a lower bond strength than the keywords appearing numerous times on a webpage. In another embodiment, proximity of keywords to a top of the webpage may increase bond strength. For example, a pair of keywords that appear together may have a higher bond strength than if the pair of words appeared near the bottom of the webpage. Various factors may affect bond strength in different ways. For example, proximity of keywords may have a greater effect on bond strength than location of a pair of keywords within a webpage. In one embodiment, bond strength is a measure of relatedness between two keywords. In another embodiment, more complex bond strengths may be included, such as a bond strength between a particular phrase and another keyword. In one embodiment, bond strengths of keywords of the search results are returned with the search results. In another embodiment, the bond strengths are returned separately from the search results. One of skill in the art will recognize other ways to characterize bond strength between keywords.

The apparatus 200 includes a keyword selection module 204 that receives a selection of two or more of the displayed keywords. For example, the keyword selection module 204 may receive a selection of keywords from a user. The keyword selection module 204 may allow a user to use a mouse to select keywords or may receive keywords via a keyboard. In another embodiment, the keyword selection module 204 may receive keywords from a file, an application, or the like. In one embodiment, the keyword selection module 204 may include an indicator of which keywords are selected. For example, the keyword selection module 204 may highlight selected keywords. In another embodiment, the keyword selection module 204 may have the selected keywords appear in another location, such as associated with a slider to select keyword bond strength. One of skill in the art will recognize other ways that the keyword selection module 204 may receive a selection of two or more displayed keywords.

The apparatus 200 includes a bond strength selection module 206 that sets a bond strength between two or more of the selected keywords. In one embodiment, the bond strength selection module 206 sets a bond strength between selected keywords that is a desired bond strength. For example, if bond strength is on a scale of one to ten, the bond strength selection module 206 may allow a user to select a bond strength of seven. In one embodiment, the bond strength selection module 206 sets a bond strength based on user input. For example, a user may choose a particular bond strength and may input the selected bond strength to the bond strength selection module 206.

In one embodiment, the bond strength selection module 206 displays a mechanism for the user to select a bond strength. In one example, the mechanism is a slider. In another example, the mechanism is a window that accepts a number or a symbol. In another embodiment, the bond strength selection module 206 displays a range of possible bond strengths. For example, the range may be from one to ten and the bond strength selection module 206 may display the range as numbers on a slide, as a numerical range, within instructions, etc. In one embodiment, the bond strength selection module 206 sets a bond strength for a first pair of keywords, a second bond strength for a second pair of keywords, etc. For example, the bond strength selection module 206 may set a bond strength of seven for keywords “mutual” and “fund” and may set a bond strength of five for keywords “fund” and “rating.”

The apparatus 200 includes a results display module 208 that displays search results with a bond strength of at least the selected bond strength. For example, if the bond strength selection module 206 sets a bond strength at seven, the results display module 208 may then identify search results with a bond strength of at least seven for the selected keywords and may display the search results with a bond strength of seven for the keywords. In another example, if the bond strength selection module 206 sets a bond strength at seven for a first pair of keywords and a bond strength of five for a second pair of keywords, the results display module 208 may then identify search results with a bond strength of at least seven for the selected first pair keywords and five for the second pair of keywords and may display the search results that meet both criteria. In one embodiment, the results display module 208 displays a subset of the search results.

In one embodiment, after the results display module 208 displays reordered search results based on a selected bond strength of a set of keywords, the keyword selection module 204 receives a selection of additional keywords and the bond strength selection module 206 selects a bond strength for the a second set of keywords. The results display module 208 may then display search results where the displayed webpages have a bond strength of at least the selected bond strength for the first set of keywords and at least the selected bond strength for the second set of keywords. In another embodiment, the results display module 208 displays search results where the displayed webpages have a bond strength of at least the selected bond strength for just the second set of keywords. One of skill in the art will recognize that the modules 202-208 of the apparatus 200 may be used with various combinations of keywords and bond strengths.

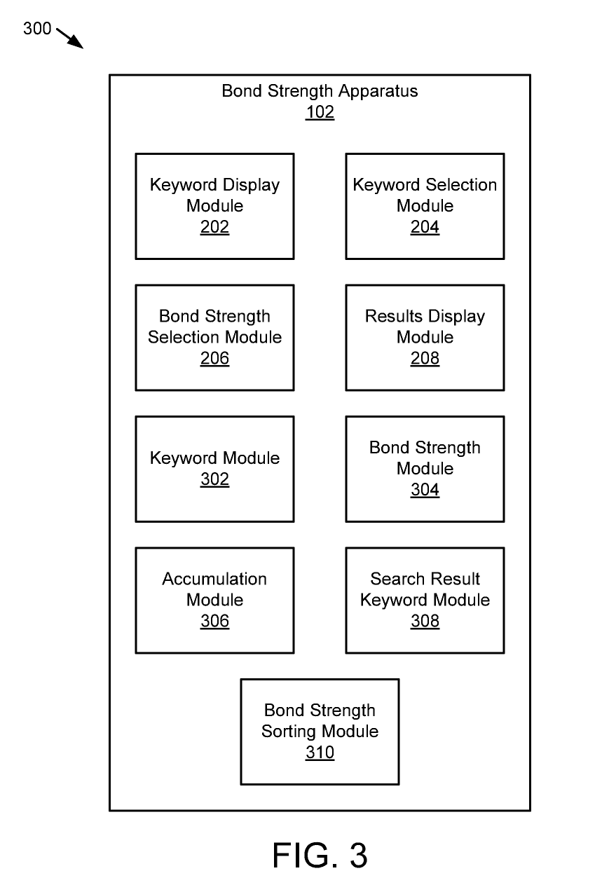

FIG. 3 is a schematic block diagram illustrating one embodiment of an apparatus 300 for reordering search results based on bond strength. The apparatus 300 includes a bond strength apparatus 102 with a keyword display module 202, a keyword selection module 204, a bond strength selection module 206, and a results display module 208, which are substantially similar to those described in relation to the apparatus 200 of FIG. 2. The apparatus 300, in various embodiments, includes a keyword module 302, a bond strength module 304, an accumulation module 306, a search result keyword module 308, and a bond strength sorting module 310, which are described below.

The apparatus 300, in one embodiment, includes a keyword module 302 that identifies keywords from a webpage. For example, the keyword module 302 may be part of a web search engine 104 that indexes keywords of webpages. In another embodiment, the keyword module 302 executes independently of a search engine. In one embodiment, the keyword module 302 associates keywords of a webpage with the webpage. For example, where the web search engine 104 returns search results with a particular webpage, the keyword module 302 may return the keywords of the webpage with the search results or may return the keywords at a later time in response to a request for keywords from the webpage. In one embodiment, the keyword module 302 identifies keywords from a webpage prior to a web search. In another embodiment, the keyword module 302 identifies keywords of a webpage identified in search results after the web search.

The apparatus 300, in one embodiment, includes a bond strength module 304 that determines a bond strength of keywords of a webpage. In one embodiment, the bond strength module 304 determines a bond strength of keywords of a webpage after the keyword module 302 identifies the keywords from the webpage. In another embodiment, the bond strength module 304 determines a bond strength of keywords of a webpage after another utility identifies the keywords from the webpage. In one embodiment, the bond strength module 304 determines a bond strength for each pair of keywords for the various combinations of keywords of the webpage. In one embodiment, the bond strengths of a webpage are stored with the keywords of the webpage. In another embodiment, the bond strength module 304 determines a bond strength of keywords for web pages of the search results after the keyword selection module 204 receives a selection of keywords of the search results. The bond strength module 304 may determine bond strength of a pair of keywords based on proximity of the keywords, location of the keywords, etc.

The apparatus 300, in one embodiment, includes an accumulation module 306 that crawls the internet to locate webpages for the keyword module 302 to identify keywords and for the bond strength module 304 to determine bond strengths and stores the keywords and the bond strengths of the webpages. For example, where the keyword module 302 and the bond strength module 304 are available to a web search engine 104, the accumulation module 306 may be used by the web search engine 104 as the web search engine 104 crawls the internet to identify and index webpages. The accumulation module 306 may use the keyword module 302 and the bond strength module 304 for each identified webpage and may store the identified keywords and determined bond strengths of the identified webpage.

The apparatus 300 includes, in one embodiment, a search result keyword module 308 that identifies the keywords from the webpages of the search results prior to the bond strength module 304 determining a bond strength of the keywords of the webpages. For example, where the bond strength apparatus 102 is part of a browser 114, a user may search the internet and may receive search results and the search result keyword module 308 along with the bond strength module 304 may identify keywords and may determine bond strengths of the keywords of the webpages in the search results. In another embodiment, it may not be desirable for a web search engine 104 to store keywords and bond strengths of identified webpages so, in conjunction with a web search using the web search engine 104, the bond strength module 304 and the search result keyword module 308 may be used in conjunction with the web search engine 104 to identify keywords from the webpages of the search results and to determine bond strengths of the keywords.

In one embodiment, the bond strength module 304 determines bond strengths of a subset of the webpages of the search results Likewise, the search result keyword module 308 may identify keyword for a subset of the webpages of the search results. For example, if a large number of search results are returned, for example 500,000 search results, the search result keyword module 308 may identify keywords from the top 10,000 webpages and the bond strength module 304 may determine bond strengths for the top 10,000 webpages. In another embodiment, the bond strength module 304 determines bond strengths for less than 10,000 of the top 10,000 webpages. For example, the subset may be chosen based on how long the search result keyword module 308 and the bond strength module 304 take to identify keywords and determine bond strengths. The subset may be chosen so that the time that the search result keyword module 308 and the bond strength module 304 take to identify keywords and determine bond strengths is a time that is acceptable to a user.

In one embodiment, the apparatus 300 includes a bond strength sorting module 310 that the search results based on the selected keywords. The results display module 208 may then display the sorted search results in an order of highest bond strengths to lowest bond strengths. The results display module 208 may cut of the sorted search results at the selected bond strengths so no search results with bond strengths below the selected bond strengths are displayed. In another embodiment, the results display module 208 displays only a portion of the sorted search results with bond strengths above the selected bond strengths. For example, if 1,000 search results have bond strengths above the selected bond strengths, the results display module 208 may display 100 of the search results. In another embodiment, the user may select a page down or other item and the results display module 208 may display another 100 results. One of skill in the art will recognize other ways to sort the search results based on bond strength.

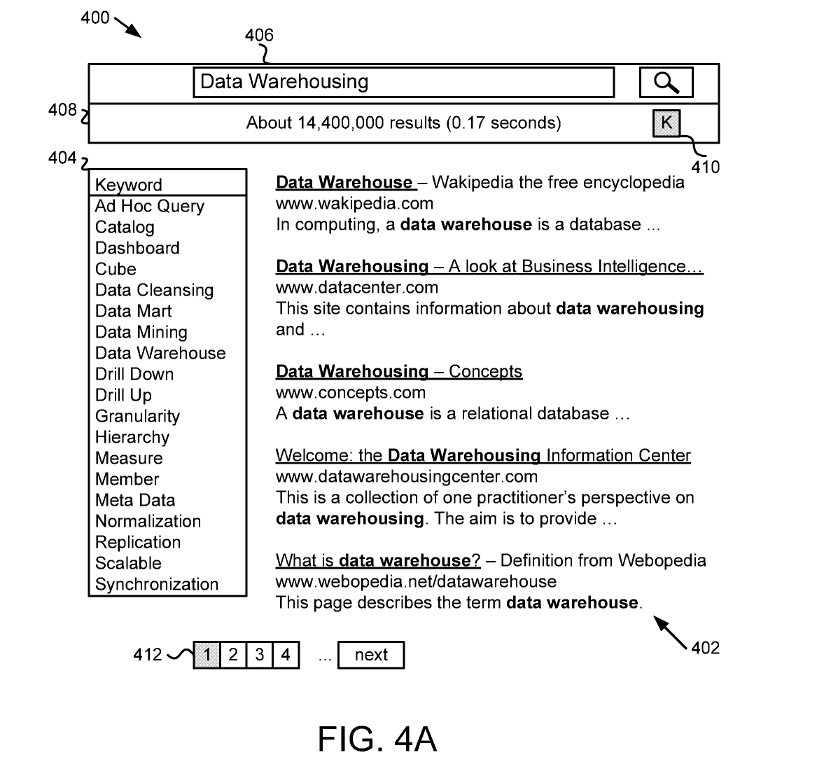

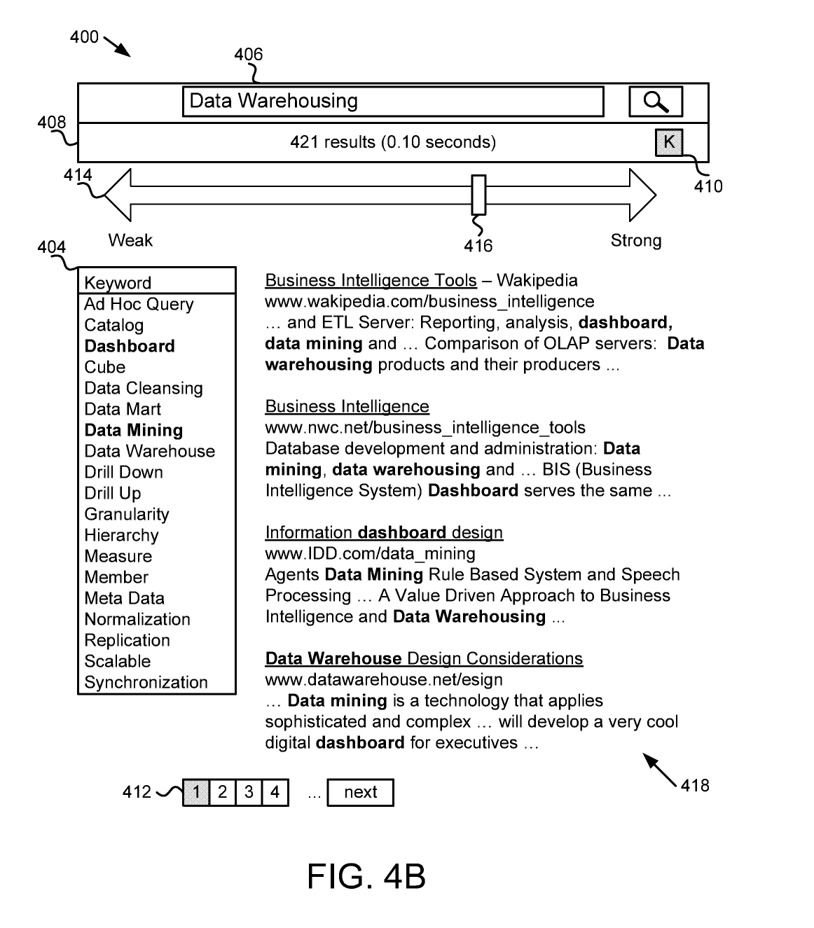

FIGS. 4A and 4B are a first part and a second part of an example 400 of a webpage of a browser 114 for reordering search results based on bond strength. In FIG. 4A, the example 400 includes a list of search results 402, a list of keywords 404, a search window 406, a display of a number of search results 408, a keyword icon 410 for displaying keywords, and a mechanism 412 to display additional search results. The search results 402 are listed for search criteria of “data warehousing.” The search results 402 in the depicted example 400 include the words of the search criteria (i.e. “data” and “warehousing”) and associated words (i.e. “warehouse”) in a bold font. The search results 402 may include a header for each search result, a URL, and text of the webpage of the search result. In other examples, the search results 402 are displayed in a different format.

The example 400 includes a list of keywords 404 displayed in a column. In other examples, the keywords 404 may be displayed in other formats. The example 400 includes a search window 406. For example, a user may type search criteria in the search window 406. The example 400 also includes a display of how many search results meet the search criteria (i.e. 14,400,000 results) and an execution time that the web search engine 104 used on the search. In one embodiment, a keyword icon 410 is included which allows a user to display the keywords 404. For example, the browser 114 may initially display search results 402, the search window 406, etc. but may not display the keywords 404 until the user selects the keyword icon 410. The example 400 also includes a mechanism 412 for the user to display additional search results. For example, the mechanism 412 may include a group of numbers where each number represents a page of search results, a forward and/or back button, a previous and/or next button, etc.

FIG. 4B depicts the keywords 404, the search window 406, the display of the number of the search results 408, the keyword icon 410, and mechanism 412 for displaying additional search results as in FIG. 4A. The keywords 404 include two selected keywords, “dashboard” and “data mining.” Note that data mining is a phrase as a keyword rather than individual words. The selected keywords are in a bold font. In other examples, the selected keywords may include a box around the selected keywords, may print the selected keywords in another location, and the like. The example 400 includes a slider bar 414 and a slider 416 that allow a user, in conjunction with the bond strength selection module 206, to select a bond strength for the selected keywords. In the example, 400 the user may move the slider 416 to select a bond strength where moving the slider 416 to the left decreases bond strength and moving the slider 416 to the right increases bond strength.

The displayed search results 418 are displayed by the results display module 208 and include search results that have a bond strength at least meeting the selected bond strength. The displayed search results 418 may also be sorted by the bond strength sorting module 310. The mechanism 412 for the user to display additional search results may be used to page through the search results 418 that have at least the selected bond strength. The display of the number of the search results 408 may be updated to include a number of search results that match the search criteria and have a bond strength of the selected keywords at least as much as the selected bond strength. One of skill in the art will recognize other examples and configurations of a display with keywords 404 for search results 402 and a way for a user to set a bond strength of selected keywords 404.

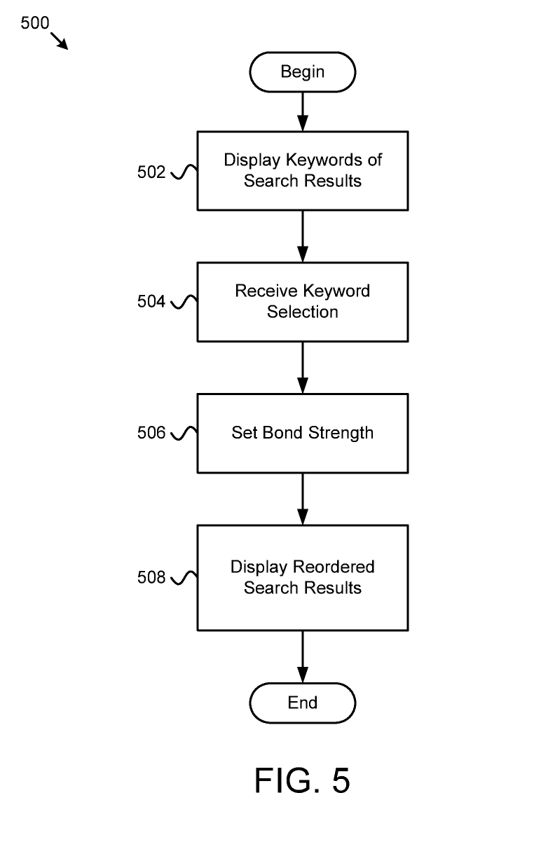

FIG. 5 is a schematic flow chart diagram illustrating one embodiment of a method 500 for reordering search results based on bond strength. The method begins and displays 502 keywords on an electronic display. The keywords, in one embodiment, are from results of an internet search of search criteria. A keyword of a search result is related to another keyword of the search result with a particular bond strength and the bond strength is an amount that keywords in a search result are related. In one embodiment, the keyword display module 202 displays the keywords.

The method 500 receives 504 a selection two or more of the displayed keywords and sets 506 a bond strength between two or more of the selected keywords. In one embodiment, the keyword selection module 204 receives 504 the selection of keywords and the bond strength selection module 206 sets 506 the bond strength of the selected keywords. The method 500 displays 508 search results with a bond strength of at least the selected bond strength, and the method 500 ends. In one embodiment, the results display module 208 displays 508 the search results.

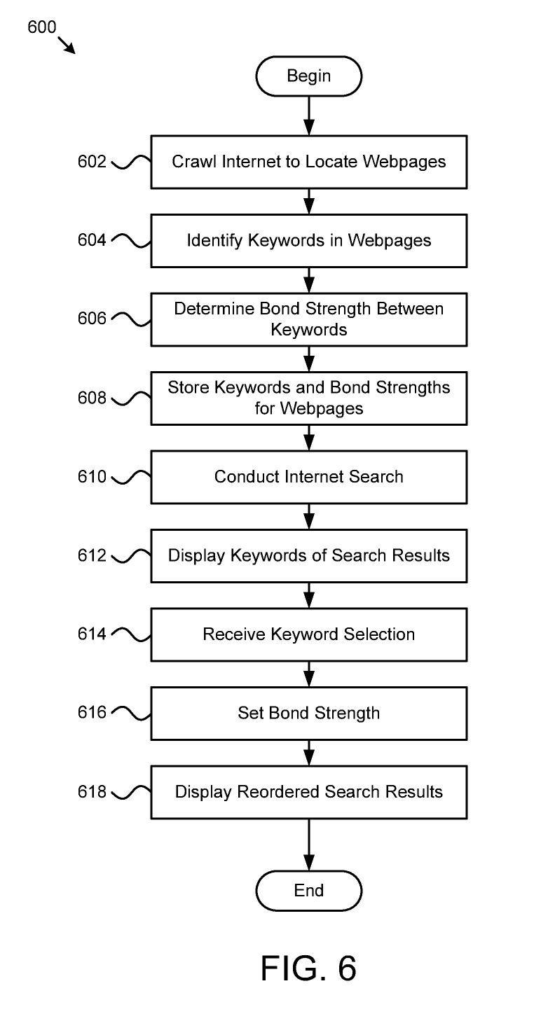

FIG. 6 is a schematic flow chart diagram illustrating another embodiment of a method 600 for reordering search results based on bond strength. The method 600 begins and crawls 602 the internet to locate webpages. For example, the web search engine 104 may crawl the internet. The method 600 identifies 604 keywords in the webpages, determines 606 bond strengths between keywords of the webpages, and stores 608 the keywords and bond strengths of the webpages. For example, the keyword module 302 and the bond strength module 304 may work in conjunction with the web search engine 104 to identify keywords in webpages and determine bond strength and the accumulation module 306 may store the keywords and bond strengths of the webpages.

The method 600 conducts 610 an internet search based on search criteria. For example, a user may use a browser 114 on a client 110 to access the web search engine 104 to conduct 610 a web search over the internet. The method 600 displays 612 keywords on an electronic display. For example, the keyword display module 202 may display 612 the keywords. The method 600 receives 614 a selection of two or more keywords of the search results and sets 616 a bond strength between two or more of the selected keywords. In one embodiment, the keyword selection module 204 receives 614 the selection of keywords and the bond strength selection module 206 sets 616 the bond strength of the selected keywords. The method 600 displays 618 search results with a bond strength of at least the selected bond strength, and the method 600 ends. In one embodiment, the results display module 208 displays 618 the search results.

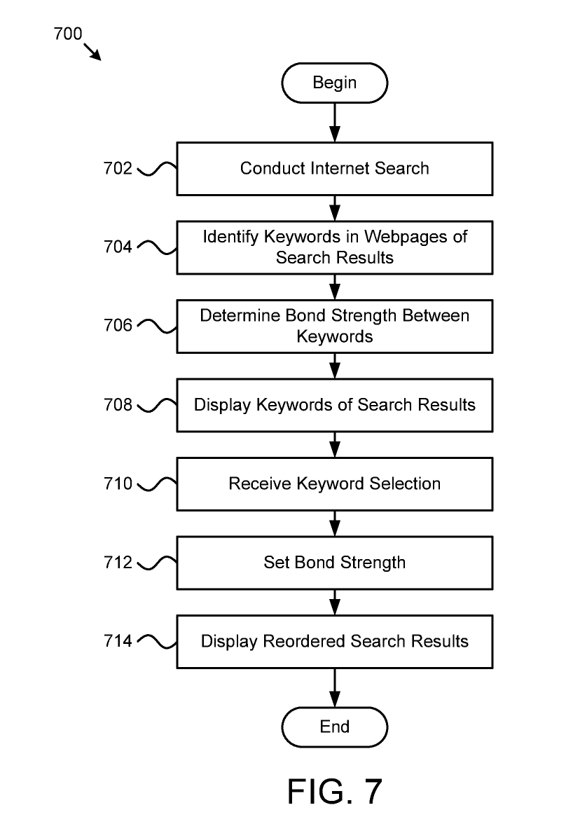

FIG. 7 is a schematic flow chart diagram illustrating one embodiment of a method 700 for reordering search results based on bond strength after a search. The method 700 begins and conducts 702 an internet search based on search criteria. For example, a user may use a browser 114 on a client 110 to access the web search engine 104 to conduct 702 a web search over the internet. The method 700 identifies 704 keywords in webpages of the search results. For example, the search result keyword module 308 may identify 704 keywords in the search results after the web search engine 104 conducts 702 a search. The method 700 determines 706 bond strengths between keywords of the search results. For example, the bond strength module 304 may determine 706 bond strengths for keywords of webpages of the search results. In one embodiment, the search result keyword module 308 and the bond strength module 304 work in conjunction with a web search engine 104. In another embodiment, the search result keyword module 308 and the bond strength module 304 work in conjunction with a browser 114. In another embodiment, the search result keyword module 308 and the bond strength module 304 work independently of a browser 114 or web search engine 104 and are part of an application.

The method 700 displays 708 keywords of the search results on an electronic display. For example, the keyword display module 202 may display 708 the keywords. The method 700 receives 710 a selection of two or more keywords of the search results and sets 712 a bond strength between two or more of the selected keywords. In one embodiment, the keyword selection module 204 receives 710 the selection of keywords and the bond strength selection module 206 sets 712 the bond strength of the selected keywords. The method 700 displays 714 search results with a bond strength of at least the selected bond strength, and the method 700 ends. In one embodiment, the results display module 208 displays 714 the search results.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a keyword display module that displays keywords on an electronic display, the keywords from results of an internet search of search criteria, wherein a keyword of a search result is related to another keyword of the search result with a particular bond strength, the bond strength comprising an amount that keywords in a search result are related;
a keyword selection module that receives a selection two or more of the displayed keywords;
a bond strength selection module that sets a bond strength between two or more of the selected keywords; and
a results display module that displays search results with a bond strength of at least the selected bond strength,
wherein at least a portion of the keyword display module, the keyword selection module, the bond strength selection module, and the results display module comprise one or more of hardware and executable code, the executable code stored on one or more computer readable storage media.

2. The apparatus of claim 1, further comprising a bond strength module that determines a bond strength of keywords of a webpage.

3. The apparatus of claim 2, further comprising a keyword module that identifies keywords from the webpage prior to the bond strength module determining a bond strength of the keywords of the webpage.

4. The apparatus of claim 3, further comprising an accumulation module that crawls the internet to locate webpages for the keyword module to identify keywords and for the bond strength module to determine bond strengths and stores the keywords and the bond strengths of the webpages.

5. The apparatus of claim 2, wherein the bond strength module determines bond strengths of the keywords of webpages within the search results.

6. The apparatus of claim 5, further comprising a search result keyword module that identifies the keywords from the webpages of the search results prior to the bond strength module determining a bond strength of the keywords of the webpages.

7. The apparatus of claim 5, wherein the bond strength module determines bond strengths of a subset of webpages of the search results.

8. The apparatus of claim 7, wherein the subset comprises a number of webpages listed first within the search results.

9. The apparatus of claim 2, wherein the bond strength module executes associated with a search engine.

10. The apparatus of claim 2, wherein the bond strength module executes associated with a browser.

11. The apparatus of claim 1, wherein the keyword display module displays a subset of the keywords.

12. The apparatus of claim 1, further comprising a bond strength sorting module that sorts the search results based on the selected keywords.

13. The apparatus of claim 1, wherein the bond strength selection module displays a slider, wherein a user moves the slider to select the bond strength.

14. The apparatus of claim 1, wherein the bond strength selection module includes a first bond strength selection for a first set of keywords and a second bond strength selection for a second set of keywords.

15. (canceled)

16. (canceled)

17. (canceled)

18. (canceled)

19. (canceled)

20. A system comprising:
a server;
a web search engine executing on the server that crawls the internet to locate webpages;
a keyword module that identifies keywords for each webpage, wherein a keyword of a search result is related to another keyword of the search result with a particular bond strength, the bond strength comprising an amount that keywords in a search result are related;
a bond strength module that determines a bond strength between keywords for each webpage;
an accumulation module that stores the keywords and bond strengths of each webpage;
a keyword display module that displays keywords on an electronic display, the keywords from results of an internet search of search criteria;
a keyword selection module that receives a selection of two or more of the displayed keywords;
a bond strength selection module that sets a bond strength between two or more of the selected keywords; and
a results display module that displays search results with a bond strength of at least the selected bond strength.
